(19) United States
(12) Patent Application Publication
(10) Pub. No.: US 2019/0054422 A1
(43) Pub. Date: Feb. 21, 2019

(54) Ceramic Membrane Module with Inflatable Assembly and Related Methods

(71) Applicant: Nanostone Water Inc., Waltham, MA (US)

(72) Inventor: Paul Osmundson, Eden Prairie, MN (US)

(73) Assignee: Nanostone Water Inc., Waltham, MA (US)

(21) Appl. No.: 16/165,944

(22) Filed: Oct. 19, 2018

Related U.S. Application Data
(63) Continuation of application No. PCT/US2017/028949, filed on Apr. 21, 2017.
(60) Provisional application No. 62/326,444, filed on Apr. 22, 2016.

(51) Int. Cl. B01D 63/02; B01D 65/00; B01D 71/02

(52) U.S. Cl. CPC B01D 63/022; B01D 65/003; B01D 2313/04; B01D 2313/025; B01D 71/02

(57) ABSTRACT

A method for forming a ceramic membrane module system includes disposing at least one membrane within a housing, where the membrane has capillaries therein. The method includes sealing the first housing end and capillaries, applying force to the removable gasket with an inflatable bladder assembly or piston assembly, and disposing potting material into the housing without plugging the capillaries with the potting material.

### CROSS-REFERENCE TO RELATED APPLICATIONS

This application is a by-pass continuation and claims priority to International Application Number PCT/US2017/028949 that was filed on Apr. 21, 2017, which claims priority to U.S. Provisional Application No. 62/326,444 that was filed on Apr. 22, 2016. The entire contents of the applications referenced above are hereby incorporated by reference herein.

### TECHNICAL FIELD

This invention relates to a ceramic membrane module with inflatable bladder assembly and related methods.

### BACKGROUND

Many waters contain contaminants that can present a hazard to people or the environment, or make further processing such as evaporation or reverse osmosis more difficult. Membrane filters are commonly used to remove such contaminants. Membrane elements are typically made of polymers or ceramics, both of which are frequently placed inside a housing to contain the pressurized fluid to be treated. The element and housing combination are referred to as membrane modules or modules. Such housings also provide separate ports to allow a feed to enter the module, filtrate to exit after being processed through the membrane, and a retentate chamber for removal of the filtered material.

Ceramic membranes that are commonly used have a multilayer structure with a relatively high permeability support, and a thinner separation layer which enables the separation by passing some components (typically water and small solutes) while retaining others. To increase surface area, a number of capillaries are typically present in the support, each with a coating. In one example of a use of the membrane, feed enters these capillaries before passing through the membrane into the support structure. In other examples, the coating is on an outside surface, and feed enters from the outside and flows inward to the capillaries. To keep feed from passing directly into the support on either end, a face end seal layer is used to prevent transport through the ends. Commonly used materials for face end seals include epoxies, polyurethanes, elastomers, glass or other suitable materials. In comparison to the other components in a ceramic membrane module, this face end seal is particularly sensitive to mechanical damage due to both the material properties of the face end seal, and the fact that housings which have been used to date leave the face end seal at the end of the housing preventing it from serving as shielding.

### SUMMARY

A module design advantageously allows the housing to protect, shield, and/or create an impingement zone or buffer space around the face end seal, improving the durability and integrity of the membrane.

Further, ceramic membrane modules are typically heavy and require mechanical support. Conventional ceramic housings require the ceramic in the housing to be supported so that the external end caps which are affixed to the bottom of the housing can be installed before use or removed while in a system to access the ceramic (e.g., to determine whether to the face end seal has occurred). This requires a method to support the weight of the ceramic above the ground, which makes routine inspections difficult to perform. This can be accomplished by recessing the element inside the housing. However to do so there is a need for a process to provide potting material to seal the element to the housing, while preventing the potting material from flowing over the end of the module and blocking capillaries. What is needed is a process to position the module within the housing and seal the capillary area on the end of the element so that potting material can be applied to mount the element within the housing without blocking capillaries.

In some embodiments, a method for forming a ceramic membrane module system includes disposing at least one membrane within a housing, where the housing has a first housing end and a second housing end, and the membrane has a first end and a second end. The membrane has capillaries therein, where the capillaries extend from at least the first end of the membrane. The method further includes disposing at least one sealing pad on the membrane, disposing an inflatable assembly within the housing adjacent to the sealing pad, disposing a retainer plate within the housing such that the inflatable assembly is disposed between the retainer plate and the sealing pad, applying force toward the membrane with a compression assembly and sealing the sealing pad against the membrane, and disposing potting material into the housing without plugging more than 15% of the capillaries with the potting material and forming a filtration assembly.

Implementations can include one or more of the following features: applying force to the membrane includes applying force with the compression assembly includes applying force with the inflatable assembly and includes inflating the inflatable assembly. Inflating the inflatable assembly includes inflating the inflatable assembly with air, with liquid, or with a fluid-like substance. The membrane is recessed from at least one of the first or second housing ends. The method further includes disposing a retainer plate within the housing such that the inflatable assembly is disposed between the retainer plate and the sealing pad. Applying force to the sealing pad includes providing force to the sealing pad with the retainer plate. The method further including applying force to the sealing pad by setting the membrane down on the inflatable assembly and using weight from the membrane to expand the inflatable assembly and seal against the sealing pad. Disposing the at least one sealing pad includes disposing a first sealing pad at the first end of the membrane, disposing a second sealing pad at the second end of the membrane, and the method further includes disposing a first inflatable assembly within the housing adjacent to the first sealing pad, disposing a second inflatable assembly within the housing adjacent to the second sealing pad, disposing a first retainer plate within the housing such that the first inflatable assembly is disposed between the first retainer plate and the first sealing pad, disposing a second retainer plate within the housing such that the second inflatable assembly is disposed between the second retainer plate and the second sealing pad, applying force to the first sealing pad with the first inflatable assembly and sealing the first sealing pad against the membrane, and applying force to the second sealing pad with the second inflatable assembly and sealing the second sealing pad against the membrane.

In some embodiments, a method for forming a ceramic membrane module system includes disposing at least one membrane within a housing, where the housing has a first housing end and a second housing end, the membrane has capillaries therein, and the capillaries extend from at least a first end of the membrane. The method further includes disposing an inflatable assembly within the housing directly adjacent to the first end of the membrane, disposing a retainer plate within the housing such that the inflatable assembly is disposed between the retainer plate and the membrane, coupling the retainer plate to the housing, applying force to the membrane with the inflatable assembly and sealing the inflatable assembly against the membrane, and disposing potting material into the housing without plugging more than 15% of the capillaries with the potting material and forming a filtration assembly.

In some embodiments, a filtration assembly formation assembly comprises a frame, a holder coupled with the frame, and a membrane disposed within the frame. The membrane extends from a first membrane end to a second membrane end, and the membrane has capillaries therein, the capillaries having capillary ends. The assembly further includes an inflatable assembly disposed near at least one end of the membrane assembly, and a retaining plate disposed near the housing, where the inflatable assembly is disposed between the retaining plate and the membrane. The inflatable assembly is configured to apply force to seal off the capillary ends when the compression assembly applies force to the inflatable assembly.

Implementations can include one or more of the following features: the inflatable assembly is filled with air. The inflatable assembly is filled with a fluid-like substance. The compression assembly includes a piston disposed within an opening of the holder, where the piston is movable relative to the holder and the membrane. The assembly further includes a sealing pad disposed directly adjacent to an each end of the membrane assembly, the sealing pads disposed directly against capillary ends of the membranes. The assembly further includes a sealing pad disposed directly adjacent to each end of the membrane assembly, the sealing pads disposed directly against capillary ends of the membranes. The inflatable assembly is disposed directly adjacent to the membrane, and the inflatable assembly configured to apply force directly to the membrane and seal off the capillary ends when force is applied to the membrane.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A illustrates a side view of a filtration assembly.

FIG. 1B illustrates an end view of a filtration assembly.

FIG. 1C illustrates a cross-sectional view of a filtration assembly taken along 1C-1C of FIG. 1A.

FIG. 1D illustrates a cross-sectional view of a filtration assembly taken along 1D-1D of FIG. 1C.

FIG. 2A illustrates a cross-sectional view of a filtration assembly.

FIG. 2B illustrates an enlarged partial cross-sectional view of FIG. 2A.

FIG. 3A illustrates a cross-sectional view of a filtration assembly.

FIG. 3B illustrates an enlarged partial cross-sectional view of FIG. 3A.

FIG. 4 illustrates a perspective cross-sectional view of a filtration assembly formation assembly.

FIG. 5 illustrates a cross-sectional view of a filtration assembly formation assembly.

FIG. 6A illustrates a perspective cross-sectional view of another embodiment of a filtration assembly formation assembly.

FIG. 6B illustrates a cross-sectional view of another embodiment of a filtration assembly formation assembly.

FIG. 7A illustrates a cross-sectional view of a filtration assembly formation assembly with bladder uninflated.

FIG. 7B illustrates an enlarged view taken at 7B of FIG. 7A.

FIG. 8A illustrates a cross-sectional view of a filtration assembly formation assembly with bladder inflated.

FIG. 8B illustrates an enlarged view taken at 8B of FIG. 8A.

FIG. 9A illustrates a cross-sectional view of a filtration assembly formation assembly.

FIG. 9B illustrates an enlarged view taken at 8B of FIG. 8A.

Like reference symbols in the various drawings indicate like elements.

### DETAILED DESCRIPTION

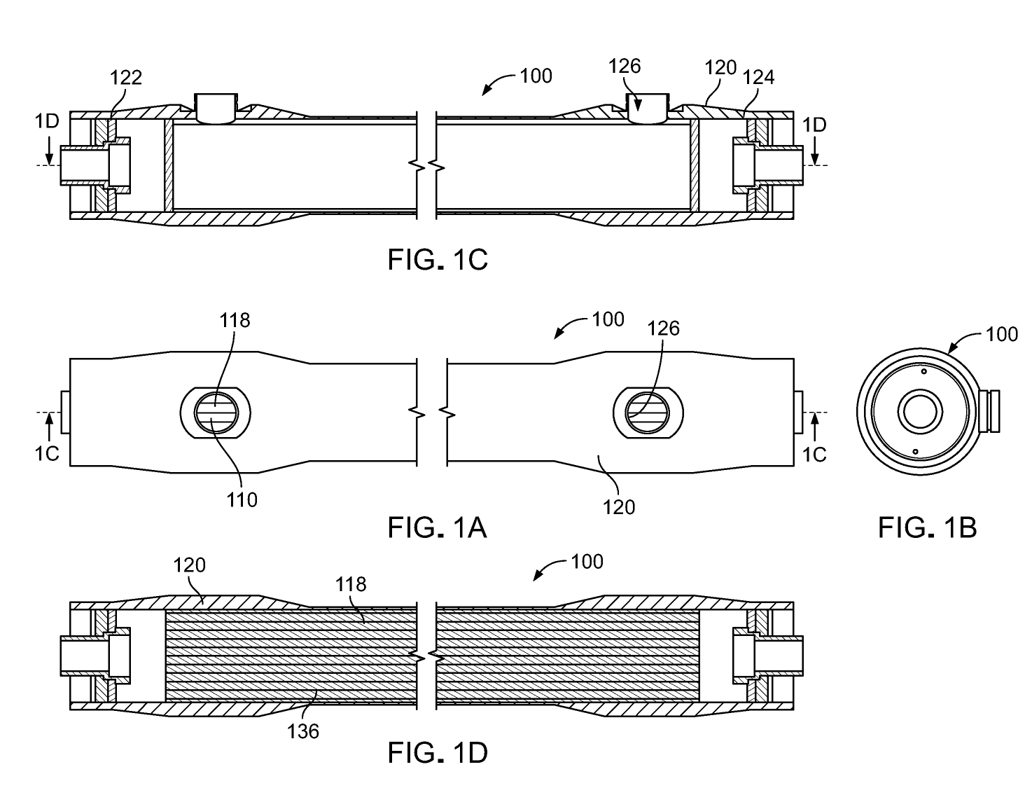

An inflatable bladder assembly and related methods are described herein, and are used to partially or fully assemble a filtration assembly. The filtration assembly 100 including a ceramic membrane system is shown in FIGS. 1A, 1B, 1C, and 1D. The system includes a ceramic membrane module 110 (see FIG. 1A) that can either be a monolithic ceramic part or be segments that when assembled and potted make up the membrane. The ceramic membrane module 110 is set back from the ends of a housing 120. The ceramic membrane module 110 (also referred to as a membrane module 110) is made, for example, using a bladder. The segments and/or monolith of the membranes 118 (e.g., ceramic membranes) are aligned and affixed set in from the ends of the housing 120 and are potted in place to allow fluid to mix in a mixing zone and evenly distribute flow over the face end of the capillary of the ceramic monolith or potted monolith.

Generally, one or more membranes 118 (e.g., flat membranes) are disposed within a housing 120. The flat membranes, in one or more embodiments, have upper and lower surfaces that are generally parallel to each other. A variety of materials can be used for the housing. In one or more embodiments, the materials include, but are not limited to, thermoplastics, fiber reinforced plastics (FRP) including acrylonitrile butadiene styrene (ABS), acetal, polyphenylene ether (PPE) resin, Nylon, polyether ether ketone (PEEK), polyethylene terephthalate (PET), polyphenylsulfone (PSU), polyetherimide (PEI), chlorinated polyvinyl chloride (CPVC), polyvinyl chloride (PVC), polypropylene (PP), polyethylene (PE), polyvinylidene fluoride (PVDF), polytetrafluoroethylene (PTFE), or combinations thereof. Thermoplastics may also include reinforcement materials such as carbon fiber, glass or ceramic particles or fibers to improve thermal and mechanical stability. Metals such as steel, stainless steel, aluminum, and titanium may also be used as a housing material. These metals may optionally be coated or modified to improve stability to the fluids and cleaning agents used during use. In one or more embodiments, the housing material includes FRP, for instance glass fiber or carbon fibers reinforced with thermosets such as epoxy.

In one or more embodiments, the housing 120 includes side ports 126. These side ports 126 provide an exit connection for purified fluids, and access to clean the membrane surface by pressurizing the filtrate and causing the flow direction to temporarily reverse. The port materials can be adjusted for the application; depending on temperature and chemical requirements, various metals alloys and gasket systems or other housing materials as indicated earlier may be used for these side ports 126.

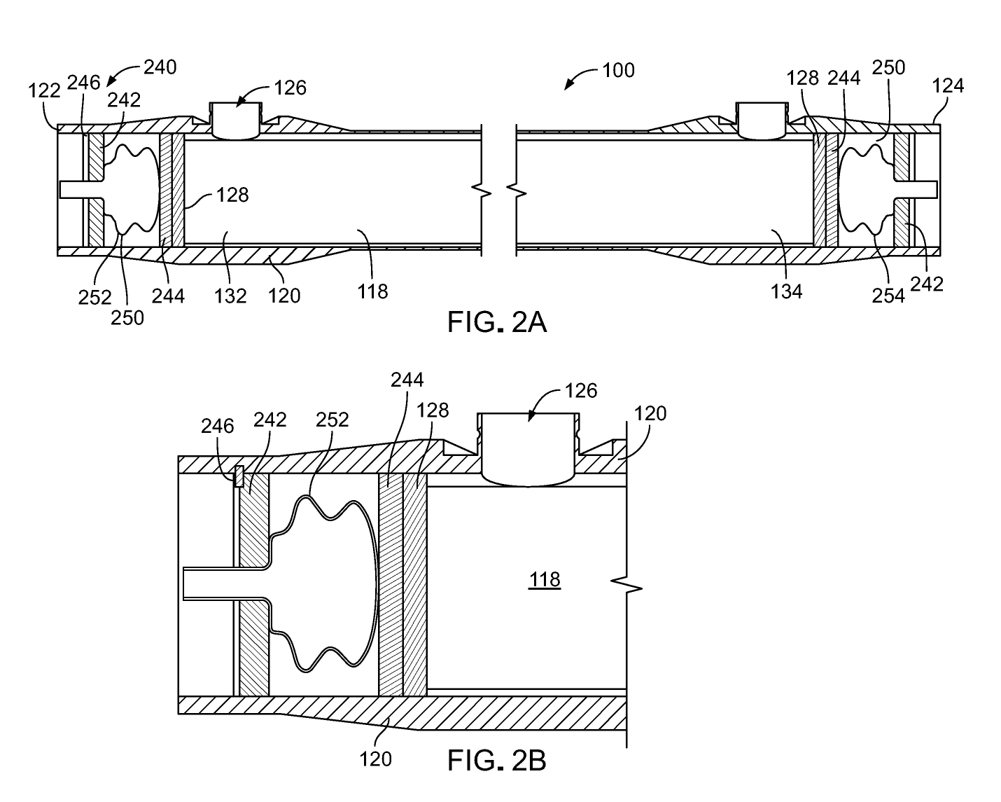

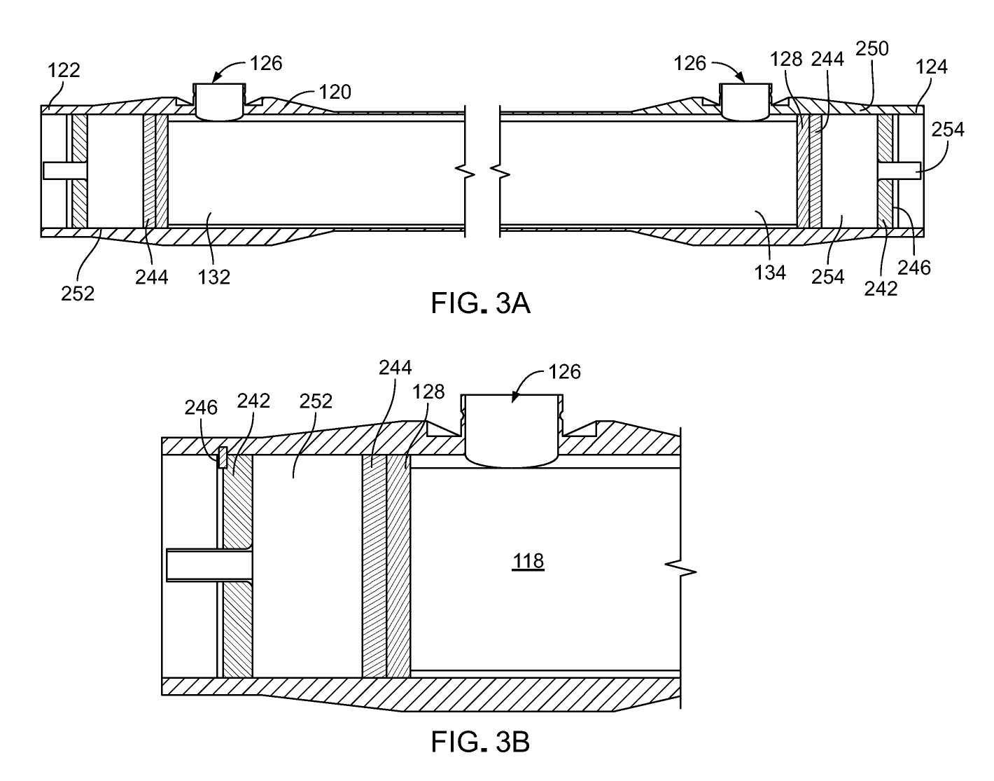

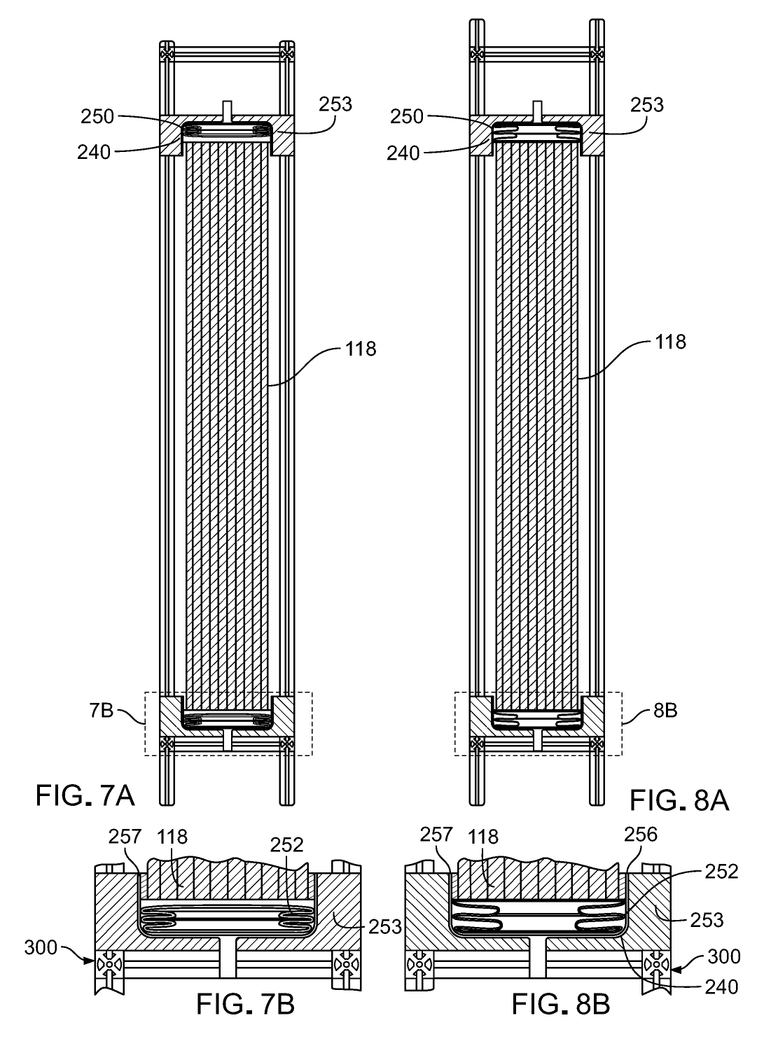

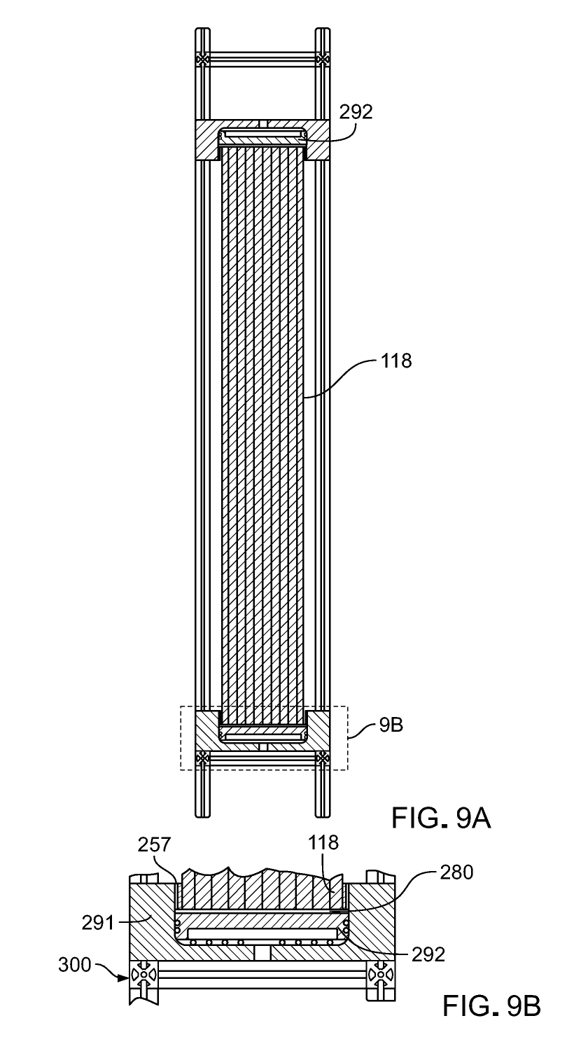

A compression assembly 240 can include an inflatable assembly 250 (see, e.g., FIG. 2A) or piston assembly (see, e.g., FIG. 9A). The compression assembly is used to partially or fully assemble the filtration assembly 100 by lining up the components, pre-potting one or more of the components, or potting the components. The compression assembly can be used with a housing 120 (FIGS. 1-3B), or with a frame assembly (FIGS. 7A-9B). The compression assembly 240 can include sources of fluids (not shown) and an inflatable assembly 250 as shown in FIG. 2A-3B. This configuration provides an easy method of assembling and fixturing ceramic membrane sealing, and sealing of a monolith assembly. The inflatable assembly 250 can also be used to pot the ceramic monolith in a housing assembly. The inflatable assembly 250 and related process allows uniform pressure to be applied to ends of the membranes and seal the capillaries 136 within the membranes, such that a sealing pad seals against the capillaries 136 within the membrane, preventing potting material from entering the capillaries 136. This avoids capillary blockage during both the monolith assembly, as well as potting of the monolith in the housing 120.

The inflatable assembly 250 is used to provide a uniform, predetermined amount of force on the seal or the membrane module 110 to ensure proper assembly and/or proper sealing. Since the housing 120 (or the frame 300 described below) withstands the pressure, a variety of end cap designs can be used interchangeably and be made of various materials to optimize performance in a given installation. For instance, in applications where a high salinity stream is used, a plastic end cap may be preferred to minimize corrosion, while in a high temperature application a metal end cap may be preferred. In one or more embodiments, the ceramic membrane is recessed within the housing 120, away from ends of the housing 122, 124. Recessing the ceramic membrane decreases the ways that damage can occur, and thus the risk of damage to the membrane.

The membrane module 110 is commonly used in a vertical orientation, but may be used in other orientations. The membrane module 110 can be supported by the edges of the base of the housing 120 or its circumference, while leaving the center region with clearance to remove the end cap and access the membrane.

The material used for the end cap can be chosen from a variety of materials. Thermoset or thermoplastics may be used, and the may be used with or without reinforcement materials. These may include ABS, Acetal, PPE resin, Nylon, PEEK, PET, PPSU, CPVC, PVC, PP, PE, PVDF, PTFE, PEI, epoxies, urethanes, or other plastics. These end caps may also be reinforced by the use of an external plate, for example, metal such as steel or aluminum. The end cap may also be made of metals, which may optionally be coated or modified to improve stability of the fluids and cleaning agents used during use.

A variety of methods have been devised to affix the end cap to the membrane module 110. For instance thrust snap rings can be used to hold the end cap in place internal to the vessel. Alternately, swing bolts, Victaulic type couplings, V− bands, union closures, or other similar closure styles can be used.

In one or more embodiments, the membrane module 110 is pre-potted (also see FIGS. 7A, 7B, 8A, 8B). For example, the membrane module 110 is positioned within a non-rigid pan. The membrane module 110 includes two or more membranes 118, and the membranes 118 have capillaries 136 therein. The capillaries 136 extend from at least a first end 132 of the membrane 118. In one or more embodiments, the capillaries 136 extend from the first end 132 to the second end 134 of each membrane 118. The inflatable assembly 250 can be used to hold the membranes 118 within the pan.

Potting material 128 is disposed within the pan and cured to hold the membranes 118 in a pre-determined position relative to one another. The potting material 128 also seals off the ends of the membranes 118 without sealing the majority of the capillaries 136. In one or more embodiments, potting material 128 is placed with less than 15% of the capillaries 136 plugged at either end of the membrane. In one or more embodiments, potting material 128 is placed with less than 10% of the capillaries 136 plugged at either end of the membrane. In one or more embodiments, inserting potting material 128 occurs with less than 5% of the capillaries 136 plugged at either end of the membrane 118.

Once the potting material 128 is cured, the pan can be removed from the end of the membranes 118. The assembly can be flipped, and the other end of the membranes 118 can be potted within the pan. In one or more embodiments, two pans can be used and the entire membrane module 110 flipped for potting the opposite end.

FIGS. 2A-3B illustrate a compression assembly for use with a method for forming a filtration assembly 100. The method includes placing a membrane module 110 within a housing 120, where the housing 120 has a first housing end 122 and a second housing end 124. The membrane module 110 can include the pre-potted module described above. The membrane module 110 includes two or more membranes 118, and the membranes 118 have capillaries 136 therein, where the capillaries 136 extend from at least a first end 132 of the membrane 118. In one or more embodiments, the capillaries 136 extend from the first end 132 to the second end of the membrane 118. The membrane 118 is recessed from at least one of the first or second housing ends 122, 124.

The method includes placing a sealing pad 244 on the membrane 118, and placing at least one compression assembly 240 such as an inflatable assembly 250 within the housing 120 adjacent to the sealing pad 244. A retainer plate 242 is disposed with the housing 120 such that the inflatable assembly is disposed between the retainer plate 242 and the sealing pad 244. In one or more embodiments, the retainer plate is mechanically restrained within the housing 120, for example, using a thrust retainer 246 which mechanically couples the retainer plate 242 with the housing 120.

Force is applied to the sealing pad 244 with the compression assembly 240, for example using the inflatable assembly 250. In one or more embodiments, the inflatable assembly 250 has an inflatable bladder 252 that can be changed from a non-inflated mode to an inflated mode. In one or more embodiments, the inflatable assembly 250 can be inflated with fluid-like material. Fluid-like material includes any liquid such as oil or water, any gas such as air, nitrogen, carbon dioxide, or argon. Fluid-like material further includes ground or crystalized solids that readily flow, such as cornstarch, fine dry sand, flax seed, etc. In one or more embodiments, fluid-like material includes malleable solids. In one or more embodiments, the temperature of the fluid-like material can be controlled and/or modified during the potting procedure, which allows for additional control over the curing of the potting material 128. In one or more embodiments, the inflatable assembly 250 can be inflated with liquid. Force applied to the sealing pad 244 seals the sealing pad 244 against the membrane 118.

In one or more embodiments, the inflatable bladder 252 itself is used to seal directly against the membrane module 110, as shown in FIGS. 6A and 6B, without the sealing pad 244. For instance, the inflatable bladder 252 is disposed within an opening 255 of a bladder holder 253. The inflatable bladder 252 seals against a side wall 256 of the opening 255. As the inflatable bladder 252 is inflated and pushes against the bladder holder 253, it seals against the membrane module 110, so that the potting material 128 can be disposed without adhering against the membrane module 110. In one or more embodiments, a potting release sleeve 257 is disposed within the opening 255.

The method of assembly further includes placing potting material 128 in the housing 120 without plugging more than 15% of the capillaries 136 with the potting material 128 and forming a filtration assembly 100. In one or more embodiments, once one end of the membrane 118 has been potted, it can be flipped and the compression assembly 240 used on the alternate side of the membrane. In one or more embodiments, the compression assembly 240 can be used on one end of the membrane 118, and thrusting the other end of the membrane into a retainer plate at the other end of the membrane 118.

In one or more embodiments, compression assembly 240, and optional sealing pad 244, can be disposed at each end of the membrane 118. For example, in one or more embodiments, the method includes placing a first sealing pad 244 at the first end of the membrane, placing a second sealing pad 244 at the second end of the membrane, placing a first inflatable assembly 250 within the housing 120 adjacent to the first sealing pad 244, and placing a second inflatable assembly 250 within the housing 120 adjacent to the second sealing pad 244. The method further includes placing a first retainer plate 242 within the housing 120 such that the first inflatable 250 assembly is disposed between the first retainer plate 242 and the first sealing pad 244, and placing a second retainer plate 242 within the housing 120 such that the second inflatable assembly 250 is disposed between the second retainer plate 242 and the second sealing pad 244, and coupling the first and second retainer plates 242 to the housing 120. The method further includes applying force to the first sealing pad 244 with the first inflatable assembly 250 and sealing the first sealing pad 244 against the membrane, and applying force to the second sealing pad 244 with the second inflatable assembly 250 and sealing the second sealing pad 244 against the membrane 118. In one or more embodiments, applying force to the first sealing pad 244 and the second sealing pad 244 occurs substantially concurrently. The method still further includes placing potting material 128 in the housing 120 without plugging more than 15% of the capillaries 136 with the potting material 128 and forming a filtration assembly 100.

As shown in FIGS. 7A, 7B, 8A, 8B, two bladders 252 and bladder holders 253 are disposed at either end of the membrane 118, and the membrane 118 and bladder holders 253 are disposed within a frame 300. FIGS. 7A and 7B show the bladder 252 in an uninflated position, and FIGS. 8A and 8B show the bladder 252 in an inflated position. The bladder holders 253 include an optional potting release sleeve 257. While the compression assembly 240 is shown at both ends, the embodiments further include a compression assembly 240 disposed only at one end of the membrane. The end of the membrane module 110 that is disposed within the bladder holder 253 is potted, cured, and then turned over to pot the other end of the membrane module 110 in this instance.

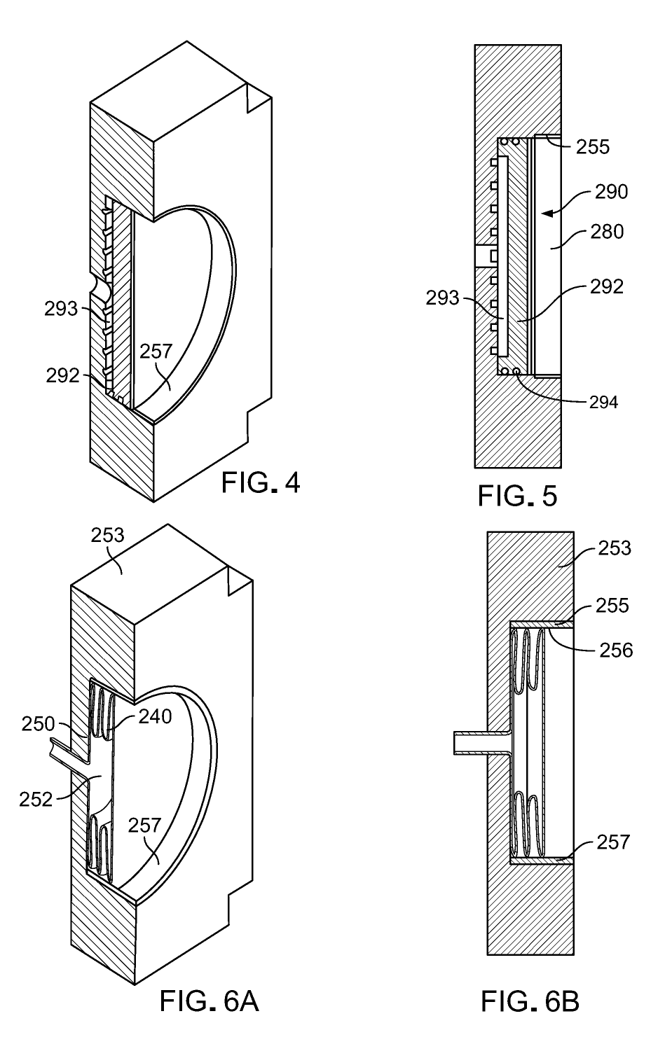

In one or more embodiments, the system includes a fluid like gap between the retention member of the frame 300 or the housing 120, and the end of the membrane module 110. FIGS. 4, 5, 9A, and 9B illustrate another embodiment of the compression assembly 240. The compression assembly 240 includes a piston assembly 290 and a pre-inflated bladder 280. The pre-inflated bladder 280 can be inflated with air or fluid, and sealed. In one or more embodiments, the pre-inflated sealed bladder 280 has a pre-determined pressure of 1-4 psi. The pre-inflated bladder 280 is disposed between the piston assembly 290 and the membrane module 110 and accommodates for an uneven or out-of-tolerance surface at the end of the membrane module 110 since there is some give to the bladder 280 when the piston assembly 290 compresses the bladder 280.

The compression assembly 240 includes a piston holder 291 for holding the piston assembly 290. The piston holder 291 furthers includes an opening 255 that receives the piston assembly 290 therein. The piston assembly 290 includes a piston 292 and a piston seal 294 which seals against a side wall of the opening as the piston 292 moves within the opening 255 to seal an end portion of the membrane module 110. The piston 292 further includes a recessed portion 293 which forms a gap to receive the driving fluid-like substance, such as, but not limited to, a fluid or air component. Fluid-like material includes any liquid such as oil or water, any gas such as air, nitrogen, carbon dioxide, or argon. Fluid-like material further includes ground or crystalized solids that readily flow, such as cornstarch, fine dry sand, flax seed, etc. In one or more embodiments, fluid-like material includes malleable solids. The piston holder 291 can include one or more grooves 295 therein adjacent the recessed portion 293, which allows for greater distribution of the driving fluid-like substance such as fluid or air.

A fluid, fluid-like substance or air source is coupled with the piston 292. The fluid or air source introduces a fluid, fluid-like substance, or air into the recessed portion 293, and is used to move the piston 292 longitudinally along the opening 255. As the piston 292 is moved, the bladder 280 (or a sealing pad 244) is compressed against the end of the membrane module 110, and sealing the end of the membrane module 110 so that potting can occur without substantially plugging the capillaries 136 of the module.

The various methods discussed above including using a compression assembly and a bladder, and placing potting material within a mold for pre-potting or within the housing 120 for potting. After the potting material is disposed within the mold or housing 120, for example with recessed potting, the potting material is cured, and the membrane module 110 is removed and can be tested. After the testing procedure, end caps are disposed on the module. Recessed potting allows a mixing zone for uniform entry into the feed side of the membrane, as well as a mixing zone. The distance also reduces the chance of abrasion caused by liquid fluid jetting. The extension of the housing walls leads to a mechanical/buffered protection of the face end seal and ceramic membrane from damage. The recessed potting allows a closure type that enables the use of a thrust snap ring closure type, a flat or domed inward or outward end cap, a swing bolt type enclosure, a v-band type closure, and other grooved type closure methods. These are cost advantages over other types of closure thus reducing the housing cost and the product cost. These methods can be used in FRP, metallic and other plastic type housings and or endcaps. In addition, the membrane module described herein allows for less expensive and more chemically resistant endcaps and closure types such as inward domed or flat endcaps secured by thrust ring/grooved closures, V-band swing bolts, screwed union or other similar methods.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope should, therefore, be determined with reference to the appended claims, along with the full scope of equivalents to which such claims are entitled.

A number of embodiments of the invention have been described. Nevertheless, it will be understood that various modifications may be made without departing from the spirit and scope of the invention. Accordingly, other embodiments are within the scope of the following claims.

1. The method of claim 18, further comprising:
placing the membrane within the housing, the housing having a first housing end and a second housing end, the membrane having a first end and a second end, the membrane having capillaries therein, the capillaries extending from at least the first end of the membrane;
placing the sealing pad on the membrane;
placing the inflatable assembly within the housing adjacent to the sealing pad; and
placing the retainer plate within the housing such that the inflatable assembly is disposed between the retainer plate and the sealing pad.

2. The method of claim 19, wherein applying force to the membrane with the compression assembly includes applying force with the inflatable assembly and includes inflating the inflatable assembly.

3. The method of claim 2, wherein inflating the inflatable assembly includes inflating the inflatable assembly with air.

4. The method of claim 2, wherein inflating the inflatable assembly includes inflating the inflatable assembly with liquid.

5. The method of claim 2, wherein inflating the inflatable assembly includes inflating the inflatable assembly with a fluid-like substance.

6. The method of claim 18, wherein the membrane is recessed from at least one of the first housing end and second housing end.

7. The method of claim 18, wherein applying force to the sealing pad includes providing force to the sealing pad with the retainer plate.

8. The method of claim 18, further comprising applying force to the sealing pad by setting the membrane down on the inflatable assembly and using weight from the membrane to expand the inflatable assembly and seal against the sealing pad.

9. The method of claim 1, wherein placing the sealing pad comprises:
placing a first sealing pad at the first end of the membrane;
placing a second sealing pad at the second end of the membrane;
placing a first inflatable assembly within the housing adjacent to the first sealing pad;
placing a second inflatable assembly within the housing adjacent to the second sealing pad;
placing a first retainer plate within the housing such that the first inflatable assembly is disposed between the first retainer plate and the first sealing pad;
placing a second retainer plate within the housing such that the second inflatable assembly is disposed between the second retainer plate and the second sealing pad;
applying force to the first sealing pad with the first inflatable assembly and sealing the first sealing pad against the membrane; and
applying force to the second sealing pad with the second inflatable assembly and sealing the second sealing pad against the membrane.

10. The method of claim 20, further comprising:
placing the membrane within the housing;
placing the inflatable assembly within the housing directly adjacent to the first end of the membrane;
placing the retainer plate within the housing such that the inflatable assembly is disposed between the retainer plate and the membrane; and
coupling the retainer plate to the housing.

11. An assembly comprising:
a frame;
a holder coupled with the frame;
a membrane disposed within the frame an extending from a first membrane end to a second membrane end, the membrane comprising capillaries therein, the capillaries having capillary ends;
an inflatable assembly disposed near at least one end of the membrane assembly; and
a retaining plate disposed between the retaining plate and the membrane
wherein the inflatable assembly is configured to apply force to seal off the capillary ends when a force is applied to the inflatable assembly.

12. The assembly of claim 11, wherein the inflatable assembly is filled with air.

13. The assembly of claim 11, wherein the inflatable assembly is filled with a fluid-like substance.

14. The assembly of claim 11, further comprising a compression assembly which comprises a piston disposed within an opening of the holder, wherein the piston is movable relative to the holder and the membrane, and the compression assembly is configured to apply the force to the inflatable assembly.

15. The assembly of claim 11, further comprising a sealing pad disposed directly adjacent to one end of the membrane assembly, wherein the sealing pad is disposed directly against capillary ends of the membranes.

16. The filtration assembly formation assembly of claim 11, further comprising a sealing pad disposed directly adjacent to each end of the membrane assembly, wherein the sealing pad is disposed directly against capillary ends of the membranes.

17. The filtration assembly formation assembly of claim 11, wherein the inflatable assembly is disposed directly adjacent to the membrane, and the inflatable assembly is configured to apply force directly to the membrane and seal off the capillary ends when force is applied to the membrane.

18. A method for forming a system which comprises, within a housing, a membrane comprising capillaries extending from a first end of the membrane, a sealing pad supported by the membrane, a retainer plate, an inflatable assembly between the retainer plate and the sealing pad, the method comprising:
applying force to the membrane to seal the sealing pad against the membrane; and
disposing potting material in the housing without plugging more than 15% of the capillaries with the potting material to provide a filtration assembly.

19. The method of claim 18, wherein applying the force comprises using a compression assembly to apply the force.

20. A method for providing a filtration assembly comprising, in a housing, a membrane comprising capillaries extending from a first end of the membrane, a retainer plate coupled to the housing, and an inflatable assembly between the retainer plate and the housing, the method comprising:
using the inflatable assembly to apply a force to the membrane to seal the inflatable assembly against the membrane; and
placing potting material into the housing without plugging more than 15% of the capillaries with the potting material and forming a filtration assembly.
